(19) United States
(12) Patent Application Publication
(10) Pub. No.: US 2026/0218735 A1
(43) Pub. Date: Jul. 30, 2026

(54) PAYLOAD MOUNTING SYSTEM AND METHOD

(71) Applicant: Swift Beat, LLC, Menlo Park, CA (US)

(72) Inventors: Jonathan Louis MILLAN, Windermere, FL (US); Kevin Lee PHELPS, Alexandria, VA (US)

(21) Appl. No.: 19/459,749

(22) Filed: Jan. 26, 2026

Related U.S. Application Data
(60) Provisional application No. 63/750,031, filed on Jan. 27, 2025.

(51) Int. Cl. F16B 2/06

(52) U.S. Cl. CPC F16B 2/065

(57) ABSTRACT

A system includes a cradle including first and second clamshells. The first clamshell includes a first ring clamp and a first mounting foot extending from the first ring clamp. The first mounting foot is configured to mount to a first mounting rail of a mobile platform type. The first ring clamp configured to: interlock with a first mounting channel of a first payload type, and interlock with the first mounting channel of a second payload type that is different than the first payload type. The second clamshell includes a second ring clamp and a second mounting foot extending from the second ring clamp. The second mounting foot is configured to mount to a second mounting rail of the mobile platform type. The second ring clamp configured to: interlock with a second mounting channel of the first payload type, and interlock with the second mounting channel of the second payload type.

### CROSS-REFERENCE TO RELATED APPLICATION

This non-provisional utility application claims priority to provisional patent application No. 63/750,031, entitled “PAYLOAD MOUNTING SYSTEM AND METHOD” and filed on Jan. 27, 2025, which is incorporated herein in its entirety by reference.

### BACKGROUND

Existing approaches for mounting payloads on mobile platforms lack flexibility across different mobile platforms.

### SUMMARY

In one aspect, a system includes a cradle including first and second clamshells. The first clamshell includes a first ring clamp and a first mounting foot extending from the first ring clamp. The first mounting foot is configured to mount to a first mounting rail of a mobile platform type. The first ring clamp is configured to: interlock with a first mounting channel of a first payload type, and interlock with the first mounting channel of a second payload type that is different than the first payload type. The second clamshell includes a second ring clamp and a second mounting foot extending from the second ring clamp. The second mounting foot is configured to mount to a second mounting rail of the mobile platform type. The second ring clamp is configured to: interlock with a second mounting channel of the first payload type, and interlock with the second mounting channel of the second payload type.

In another aspect, a system includes a first mounting rail of a mobile platform type, a second mounting rail of a mobile platform type, and a cradle including first and second clamshells. The first clamshell includes a first ring clamp and a first mounting foot extending from the first ring clamp. The first mounting foot is configured to mount to the first mounting rail. The first ring clamp is configured to: interlock with a first mounting channel of a first payload type, and interlock with the first mounting channel of a second payload type that is different than the first payload type. The second clamshell includes a second ring clamp and a second mounting foot extending from the second ring clamp. the second mounting foot is configured to mount to the second mounting rail. The second ring clamp is configured to: interlock with a second mounting channel of the first payload type, and interlock with the second mounting channel of the second payload type.

In another aspect, a method includes interlocking a ring clamp of a clamshell with a mounting channel of a first payload type, disconnecting the ring clamp from the mounting channel of the first payload type, and interlocking the ring clamp of the clamshell with a mounting channel of a second payload type, wherein the second payload type is different from the first payload type.

### BRIEF DESCRIPTION OF THE DRAWINGS

FIG. 1 is a perspective view illustrating a system for mounting a payload on a mobile platform according to an implementation.

FIG. 2 is a perspective view of a clamshell of a cradle of the system shown in FIG. 1 according to an implementation.

FIG. 3 is a perspective view of another clamshell of the cradle shown in FIG. 1 according to an implementation.

FIG. 4 is a perspective view of a casing of the payload shown in FIG. 1 according to an implementation.

FIG. 5 is a perspective view of another payload for mounting on the mobile platform using the system shown in FIG. 1 according to an implementation.

FIG. 6 is a cross sectional perspective view illustrating a payload mounted on a mobile platform type utilizing the system shown in FIG. 1 according to an implementation.

FIG. 7 is a cross sectional view of FIG. 6.

FIG. 8 is a cross sectional perspective view illustrating a payload mounted on another mobile platform type utilizing the system shown in FIG. 1 according to an implementation.

FIG. 9 illustrates perspective views of a modularity of a payload according to an implementation.

FIG. 10 illustrates perspective views of the modularity of the payload according to an implementation.

FIG. 11 is a flowchart illustrating a method of operation of the system of FIG. 1 according to an implementation.

### DETAILED DESCRIPTION

Existing approaches for mounting payloads on mobile platforms lack flexibility across different mobile platforms. For example, known payload mounting systems are often fixed, bespoke designs that are tailored for specific mobile platforms. The fixed bespoke design of known payload mounting systems limits the adaptability, flexibility, and rapid configuration capabilities of known systems, and may increase costs associated with the development of new and/or reconfigured mobile platforms. For example, there are logistical hurdles when reconfiguring mobile platforms for different tasks, such as swapping out payloads, adapting payload configurations, and/or reconfiguring payloads. Known systems may require manual adjustments and/or modifications (e.g., intricate, complex, etc.), for example to accommodate various platform geometries and/or mounting specifications, which may lead to increased labor demands, costs, and/or installation errors. Examples of installation errors suffered by known payload mounting systems include installing a payload in an improper orientation, failing to adequately secure a payload, and/or the like. An incorrect installation of a payload may pose safety risks, compromise operational integrity, reduce performance, and/or the like.

In contrast, aspects of the disclosure provide systems for mounting a variety of differently configured payloads to different types of mobile platforms. The systems disclosed herein provide standardized and configurable cradles that facilitate payload and configuration changes and enable compatibility across various types of payloads and various types of mobile platforms, for example reducing the time, cost, labor, difficulty, and/or complexity of payload and/or configuration changes.

Aspects of the disclosure are operable in a range of applications including, but not limited to: agricultural applications, surveillance and/or security applications, emergency response, disaster response and/or management, environmental and/or conservation applications, infrastructure applications, and/or the like.

In an example agricultural implementation, aspects of the disclosure enable interchangeable payload modules, such as crop sensors, spraying systems, imaging equipment, and/or the like, to be relatively quickly and easily swapped and/or reconfigured, for example based on seasonal needs, crop monitoring requirements, and/or the like. In some examples, the clamshells disclosed herein ensure proper installation and/or orientation, enhancing the efficiency and/or accuracy of agricultural tasks conducted via mobile platforms.

An example implementation of the systems disclosed herein for surveillance and/or security include enabling relatively quick adaptation to the changing needs of monitoring and/or security operations. For example, payloads such as cameras, infrared sensors, and/or communication relays can be easily interchanged, ensuring that the mobile platform can be relatively quickly deployed with the configuration best suited to the current operations.

Disaster response and/or management is another example implementation of the disclosure. For example, in emergency response scenarios, mobile platforms equipped with the systems disclosed herein can be readily adapted to carry various payloads, such as medical supplies, communication devices, environmental sensors, and/or the like. The ease of changing configurations provided by aspects of the disclosure enables for relatively rapid deployment, for example to address evolving needs in disaster-stricken areas.

In another example, aspects of the disclosure are implemented in environmental monitoring and/or conservation applications. For example, the compatibility of the disclosed systems across different types of mobile platforms and different types of payloads facilitates use in environmental monitoring. In some examples, mobile platforms are outfitted with sensors to collect data on atmospheric conditions, pollution levels, wildlife populations, and/or the like. The relatively quick payload and payload configuration interchange enabled by the systems disclosed herein underscores the mobile platform's ability to shift focus, for example as required by environmental agencies, changing environmental conditions, and/or the like.

Infrastructure inspection and/or maintenance examples of the disclosure include the inspection of infrastructure such as, but not limited to, bridges, power lines, pipelines, and/or the like. For example, the systems and methods disclosed herein can be used to adapt, configure, and change payloads designed for visual inspections, thermal assessments, ultrasonic testing, and/or the like, for example to relatively quickly match inspection types needed for different projects.

In a military application, the systems disclosed herein can facilitate relatively rapid swapping of warheads with differing ordnance, for example enabling the mobile platform to transition relatively swiftly to provide different levels of firepower, battery capacity, and/or the like. For example, a mobile platform equipped with a specific payload configuration for reconnaissance can be quickly reconfigured with a heavier ordnance for combat deployment.

Aspects of the disclosure operate in an unconventional manner at least by providing a system that includes a cradle including first and second clamshells. The first clamshell includes a first ring clamp and a first mounting foot extending from the first ring clamp. The first mounting foot is configured to mount to a first mounting rail of a mobile platform type. The first ring clamp is configured to: interlock with a first mounting channel of a first payload type, and interlock with the first mounting channel of a second payload type that is different than the first payload type. The second clamshell includes a second ring clamp and a second mounting foot extending from the second ring clamp. The second mounting foot is configured to mount to a second mounting rail of the mobile platform type. The second ring clamp is configured to: interlock with a second mounting channel of the first payload type, and interlock with the second mounting channel of the second payload type.

Aspects of the disclosure operate in an unconventional manner at least by providing a method that includes interlocking a ring clamp of a clamshell with a mounting channel of a first payload type, disconnecting the ring clamp from the mounting channel of the first payload type, and interlocking the ring clamp of the clamshell with a mounting channel of a second payload type, wherein the second payload type is different from the first payload type.

Example technical solutions to the example technical problems described herein include standardized and configurable cradles that facilitate payload and configuration changes and enable compatibility across various types of payloads and various types of mobile platforms. For example, the standardized and configurable cradles disclosed herein are configured to securely hold a variety of different types of payloads and/or payload configurations. The cradles disclosed herein enable aspects of the disclosure to provide the technical effect of reducing the time, cost, labor, difficulty, complexity, and/or the like of payload and/or configuration changes, for example overcoming the inflexibility of the fixed mounts of known systems. The standardized cradles disclosed herein provide technical solutions that provide the technical effects of, for example: reducing development costs; facilitating cross-platform interoperability; simplifying payload installation, reconfiguration, and/or replacement; decreasing downtime; reducing redeployment times; increasing the efficiency of operations in dynamic environments; and/or the like.

Another example technical solution provided by the disclosure includes the utilization of geometry-based verification features. The geometry-based verification features enable aspects of the disclosure to provide the technical effect of ensuring correct orientation and mitigating the risk of improper installation, thereby enhancing safety and reducing installation errors. For example, aspects of the disclosure provide the technical solution of employing geometric features that enforce singular correct alignment to secure the proper fit and orientation of mounted components, for example providing the technical effects of reducing the risk of installation errors, enhancing and/or reinforcing operational safety, and/or ensuring system integrity.

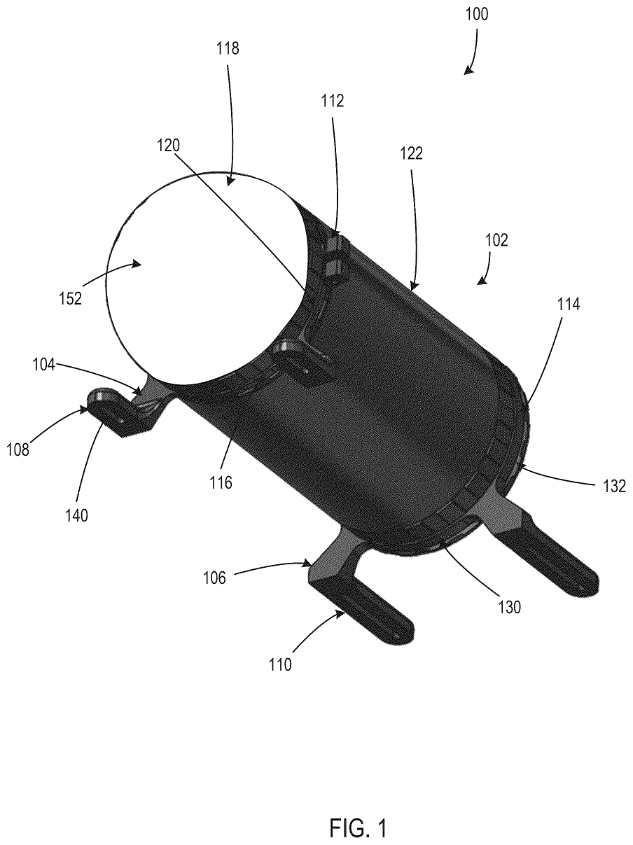

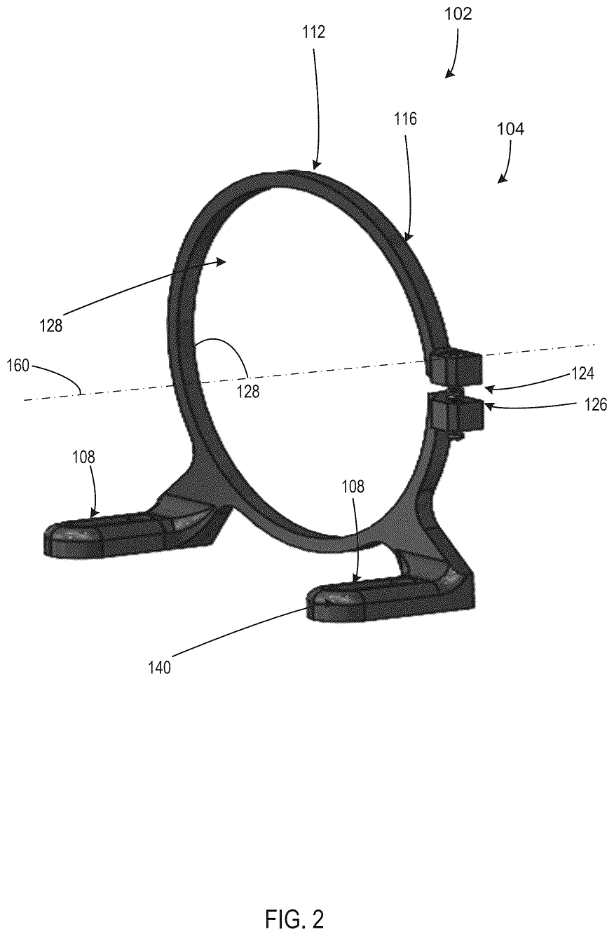

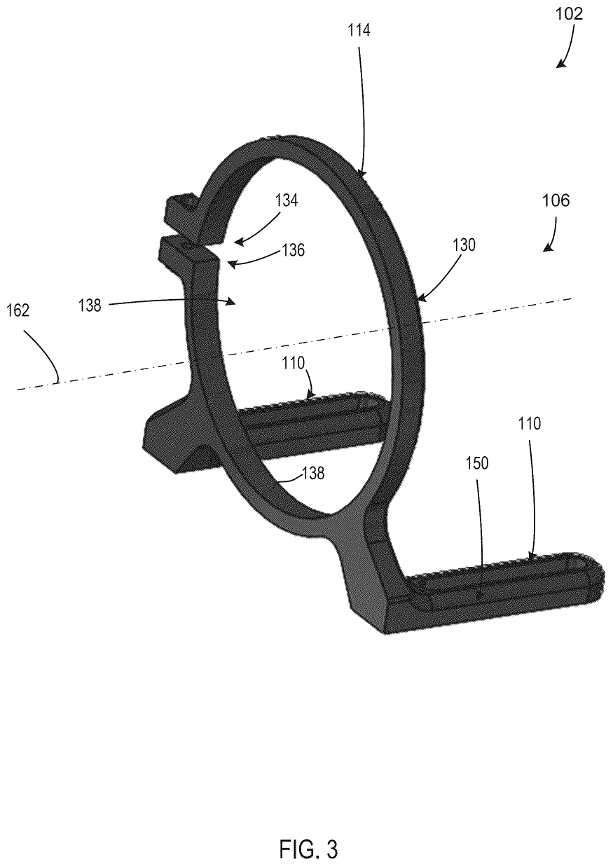

Referring to the figures, FIG. 1 is a perspective view illustrating a system 100 for mounting a payload on a mobile platform. The system 100 includes a cradle 102 that includes clamshells 104 and 106, which are illustrated in FIG. 2 and FIG. 3, respectively. Each clamshell 104 and 106 includes one or more respective mounting feet 108 and 110. The clamshells 104 and 106 include ring clamps 112 and 114, respectively, from which the respective mounting feet 108 and 110 extend. The cradle 102 is standardized and configurable such that the cradle 102 is configured to mount a variety of differently configured payloads to different types of mobile platforms and thereby facilitate payload and configuration changes and enable compatibility across various types of payloads and various types of mobile platforms. Each of the clamshells 104 and 106 may be referred to herein as a “first” and/or a “second” clamshell. The mounting feet 108 and 110 and the ring clamps 112 and 114 may each be referred to herein as a “first” and/or a “second” mounting foot or ring clamp, respectively.

Examples of mobile platforms include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), marine vehicles (e.g., boats, ships, etc.), surface vehicles, submersibles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. As used herein, the system 100 may be used onboard a mobile platform while the mobile platform is moving and/or while the mobile platform is stationary. In some examples, the system 100 is used onboard an uncrewed, autonomous mobile platform. In some examples, the system 100 is used with a stationary platform. Examples of stationary platforms include, but are not limited to, stations, arrays, central controls, centralized control stations, towers, cellular towers, fixed positions, fixed structures, stationary vehicles, uncrewed stationary platforms, autonomous stationary platforms, buildings, emplacements, installations, ground-based installations, forts, prisons, government locations, government buildings, stadiums, parks, public spaces, infrastructure, dams, public venues, private venues, concert venues, sporting venues, and/or the like.

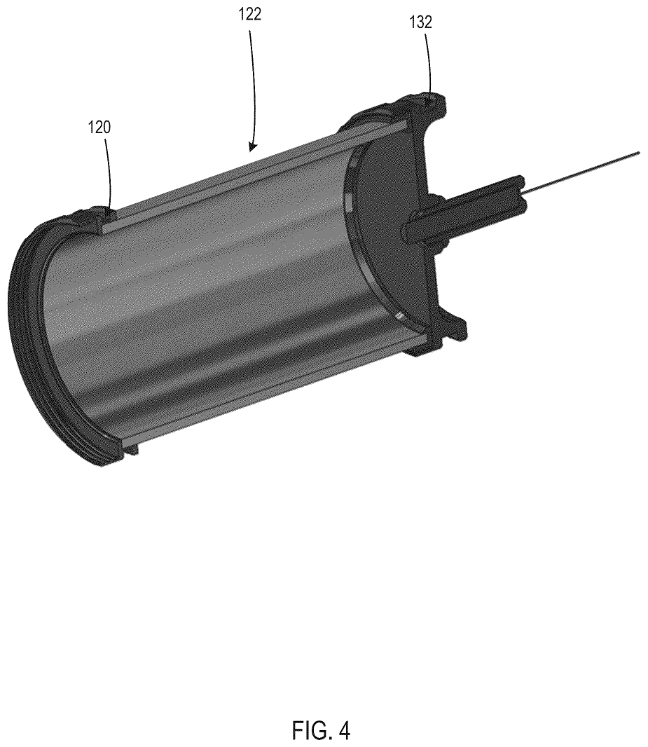

Referring now to FIGS. 1 and 2, the ring clamp 112 of the clamshell 104 includes a ring-shaped body 116 that is configured to receive a portion (e.g., a forward and/or front portion, etc.) of a payload 118 (not shown in FIG. 2) therein. The body 116 of the ring clamp 112 is configured to interlock (e.g., be received within, engaged with, engaged within, etc.) with a mounting channel 120 (not shown in FIG. 2) of a casing 122 (not shown in FIG. 2) of the payload 118. The mounting channel 120 is best seen in FIG. 4. As used herein, “ring” is meant only as a general curved shape and is not limited to a circular shape, but rather includes non-circular shapes. Moreover, the ring clamps of the disclosure (e.g., the ring clamps 112 and 114, etc.) are not limited to including curved bodies. Rather, it is contemplated that the ring clamps of the disclosure include rectangular and/or other non-curved shapes. Although shown has having a cylindrical shape, additionally or alternatively the payload 118 may include any other shape. The mounting channel 120 may be referred to herein as a “first” and/or “second” mounting channel.

The body 116 of the ring clamp 112 includes opposing free end portions 124 and 126 (not labeled in FIG. 1). The body 116 is at least partially flexible, resilient, and/or the like such that the end portions 124 and 126 are configured to be moved (e.g., separated, pulled, etc.) away from each other to provide an opening therebetween. The end portions 124 and 126 are configured to be moved (e.g., pushed, forced, squeezed, etc.) toward each other to secure the body 116 of the ring clamp 112 to the mounting channel 120. For example, moving the end portions 124 and 126 toward each other tightens the diameter of an opening 128 (not labeled in FIG. 1) of the body 116 of the ring clamp 112 such that the body 116 is moved into a clamped position wherein the body 116 is received within the mounting channel 120 and the body 116 is engaged with a bottom wall and/or one or more sidewalls of the mounting channel 120. Although a threaded fastener is shown, any other type of fastener may be additionally or alternatively be used to: move the end portions 124 and 126 toward and/or away from each other; hold the end portions 124 and 126 in a clamped and/or open position; and/or the like. Examples of other fasteners include, but are not limited to, a clip, a latch, a clamp, a bayonet-type fastener, a quarter or half-turn fastener, a spring, a spring-loaded fastener, etc.

Referring now to FIGS. 1 and 3, the ring clamp 114 of the clamshell 106 includes a ring-shaped body 130 that is configured to receive a portion (e.g., a rearward and/or rear portion, etc.) of the payload 118 (not shown in FIG. 3) therein. The body 130 of the ring clamp 114 is configured to interlock with a mounting channel 132 (not shown in FIG. 3, best seen in FIG. 4) of the casing 122 (not shown in FIG. 3) of the payload 118. The mounting channel 132 may be referred to herein as a “first” and/or “second” mounting channel.

The body 130 of the ring clamp 114 includes opposing free end portions 134 and 136 (not labeled in FIG. 1). The body 130 is at least partially flexible, resilient, and/or the like such that the end portions 134 and 136 are configured to be moved away from each other to provide an opening therebetween. The end portions 134 and 136 are configured to be moved toward each other to secure the body 130 of the ring clamp 114 to the mounting channel 132. For example, moving the end portions 134 and 136 toward each other tightens the diameter of an opening 138 of the body 130 of the ring clamp 114 such that the body 130 is moved into a clamped position wherein the body 130 is received within the mounting channel 132 and the body 130 is engaged with a bottom wall and/or one or more sidewalls of the mounting channel 132. Although a threaded fastener is shown, any other type of fastener may be additionally or alternatively be used to: move the end portions 134 and 136 toward and/or away from each other; hold the end portions 134 and 136 in a clamped and/or open position; and/or the like.

Referring now to FIGS. 1-3, the ring clamps 112 and 114 are standardized to fit (e.g., to interlock with, to be complementary with, etc.) standard mounting channels that are shared by a variety of different payload types and/or payload configurations. For example, the body 116 and 130 of each of the respective ring clamps 112 and 114 is configured to interlock with a corresponding standard mounting channel (that is shared by various different payload types and/or configurations) such that the body 116 and 130 can securely clamp to the casing of the payload via the corresponding standard mounting channel. In some examples, the ring clamps 112 and 114 are configured to fit the same standard of mounting channel, while in other examples the ring clamps 112 and 114 are configured to fit different standards of mounting channels.

In an example implementation, the body 116 of the ring clamp 112 is sized and shaped to interlock with the mounting channel 120, which is a standard mounting channel. The mounting channel 132 is another standard mounting channel that is a different standard than the standard of the standard mounting channel 120 (i.e., the mounting channel 120 is a different type of standard than the mounting channel 132). The body 130 of the ring clamp 114 is sized and shaped to interlock with the standard type of the standard mounting channel 132. Accordingly, an example implementations of the ring clamps 112 and 114 are configured to mount to different standard types of mounting channels. For example, the standard mounting channel 132 is wider than the standard mounting channel 120. The thickness of the body 116 of the ring clamp 112 along a central axis 160 (not shown in FIG. 1) of the ring clamp 112 is therefore smaller than the thickness of the body 130 of the ring clamp 114 along a central axis 162 (not shown in FIG. 1) of the ring clamp 114. In other words, the body 116 of the ring clamp 112 is narrower (along the central axes 131 and 133, respectively) as compared to the body 130 of the ring clamp 114 to accommodate the smaller (e.g., narrower, etc.) width of the mounting channel 120 as compared to the wider mounting channel 132.

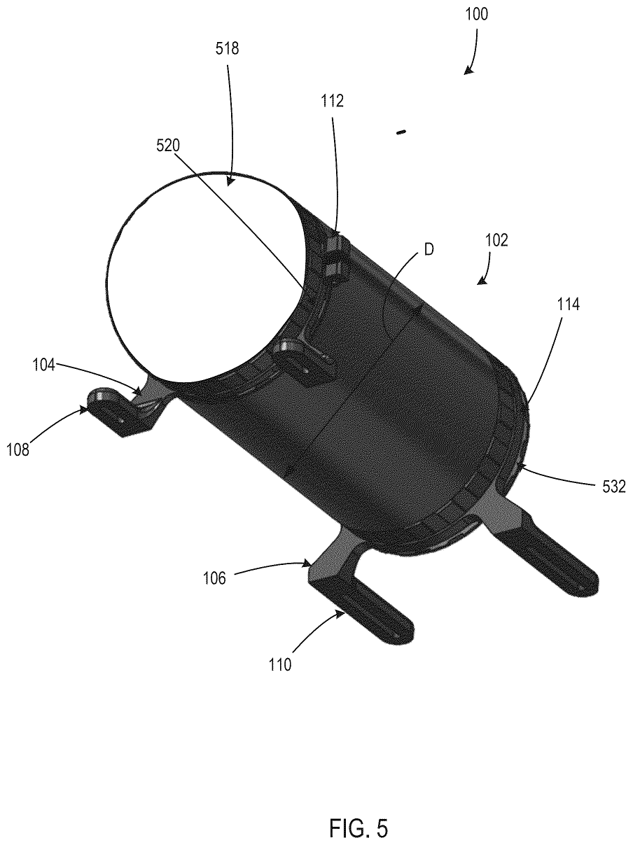

Moreover, the flexibility, resilience, and/or the like of the bodies 116 and 130 of the ring clamps 112 and 114, respectively, enables the ring clamps 112 and 114 to fit standard mounting channels across a range of different payload sizes (e.g., diameters, widths, heights, thicknesses, etc.) and/or shapes that share the same standard mounting channels. For example, example implementations of the ring clamps 112 and 114 are configured to interlock with the standard mounting channels 120 and 132, respectively, of the payload 118. However, the ring clamps 112 and 114 may also be configured to interlock with a different payload (e.g., the payload 518 shown in FIG. 5, another payload, etc.) that includes the standard mounting channels 120 and 132 but has a greater or lesser size than the size of the payload 118 (and/or a different shape as compared to the shape of the payload 118).

For example, FIG. 5 illustrates a different payload 518 that is configured to be mounted on the mobile platform using the system 100. The payload 518 includes mounting channels 520 and 532, which are the same standard as the mounting channels 120 and 132 (shown in FIG. 1) of the payload 118 (FIG. 1). The payload 518 has a smaller size as compared to the payload 118. For example, in the exemplary implementation of FIG. 5, the payload 518 has a smaller diameter D as compared to the payload 118, such that the mounting channels 520 and 532 have a smaller diameter as compared to the mounting channels 120 and 132, respectively. As shown in FIG. 5, the ring clamps 112 and 114 of the cradle 102 are interlocked with the mounting channels 520 and 532, respectively, of the payload 518 such that the payload 518 is held by the cradle 102. Each of the payloads 118 and 518 may be referred to herein as a “first” and/or a “second” payload type.

Referring again to FIGS. 1-3, in some examples, the ring clamps 112 and/or 114 incorporate geometry-based verification features that employ geometries that enforce singular alignment orientations to secure the proper fit and orientation of the payload to the mobile platform. For example, the bodies 116 and 130 of the respective ring clamps 112 and 114 may include different geometries to prevent the payload 118 from being installed in all but one orientation. In an example implementation, the different geometries of the ring clamps 112 and 114 prevent the bodies 116 and 130 from fitting within the non-corresponding mounting channels 132 and 120, respectively, when the orientation of the payload 118 is reversed (e.g., backwards, etc.) from the orientation shown in FIG. 1. For example, the thicker (e.g., wider, etc.) body 130 of the ring clamp 114 does not fit in the mounting channel 120 when the orientation of the payload 118 is reversed (from FIG. 1) such that the payload 118 cannot be installed to the cradle 102 in the reversed (and incorrect) orientation. If both of the bodies 116 and 130 had the thickness of the narrower body 116, the bodies 116 and 130 would fit within the non-corresponding mounting channels 132 and 120, thereby enabling the payload 118 to be held by the cradle 102 in the incorrect reverse orientation.

Although an example implementation utilizes different thicknesses (e.g., widths, etc.) of the bodies 116 and 130 to provide the geometry-based verification features, any other geometry-based verification feature may additionally or alternatively be used, such as, but not limited to, a shape, a height, a depth, a length, a diameter, a cross-sectional size, and/or the like. Examples of geometry-based verification features that include a difference in shape between the ring clamps 112 and 114 include, but are not limited to, a key, an irregular shape, a textured surface, a complex shape, a multi-sided shape, a barb, an extension, a finger, a stub, and/or the like.

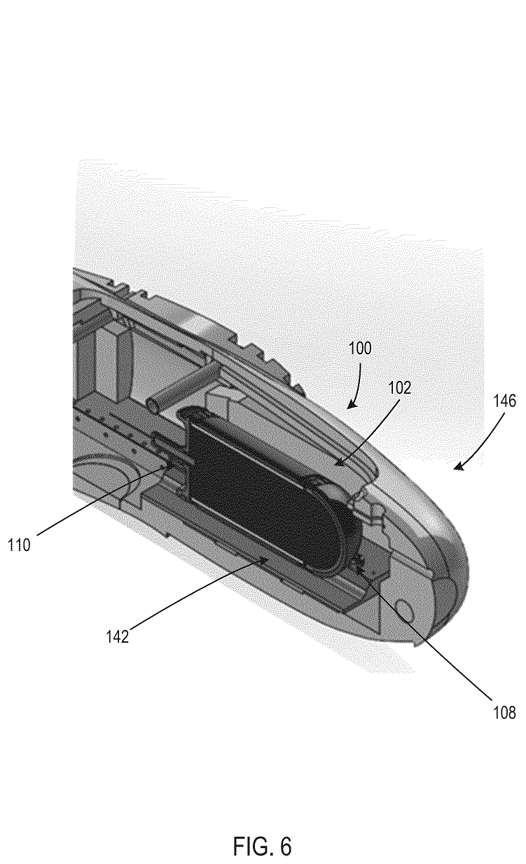

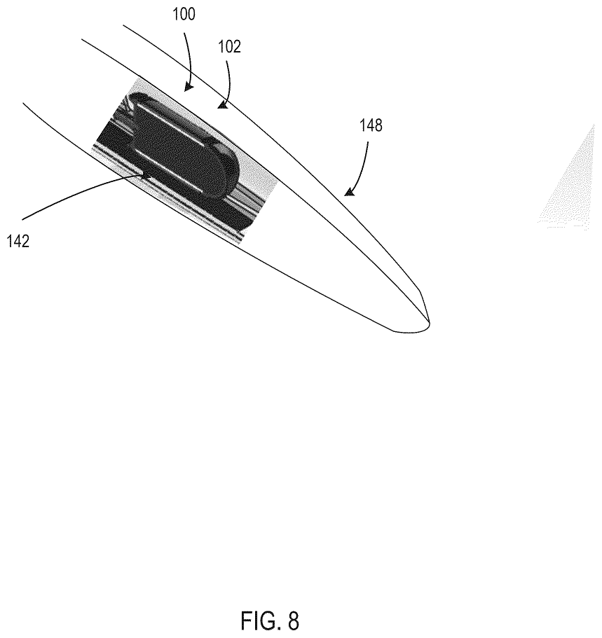

Referring again to FIGS. 1 and 2, the mounting foot 108 of the clamshell 104 includes an elongated body 140 that extends outwardly from the ring clamp 112 of the clamshell 104. The body 140 of the mounting foot 108 is configured to mount to a specific corresponding mount type (e.g., a mounting rail, an opening, etc.) of one or more specific corresponding mobile platform types. An example of a mount type shared by two different example mobile platform types 146 and 148 is shown in FIGS. 6-8 (the mounting feet 108 are not visible in FIG. 8) and includes mounting rails 142. Only the forward section of the mobile platform types 146 and 148 are shown for clarity, although the mounting rails 142 may be located in other sections of the mobile platform types 146 and 148. The example mounting feet 108 are configured to mount to each of the mounting rails 142 and are shown in FIGS. 6-8 as mounted thereto. Although two are shown, the clamshell 104 may include any number of the mounting feet 108. Each of the mounting rails 142 may be referred to herein as a “first” and/or a “second” mounting rail.

In an example implementation, the mounting feet 108 are configured to mount to the corresponding mount type by being bolted to the corresponding mounting rail 142. However, the mounting feet 108 may additionally or alternatively be configured to mount to the corresponding mount type using any other fastener, fit, structure, means, geometry, mechanism, and/or the like. For example, the example mounting feet 108 generally have a rectangular cross-sectional shape and extend outward from the ring clamp 112 along an approximately straight path and with an orientation that extends approximately parallel to the central axis of the ring clamp 112. In other words, each of the example mounting feet 108 extends longitudinally outward from the ring clamp 112 along the central axis 160 of the ring clamp 112. However, each mounting foot 108 may additionally or alternatively include any other geometry (e.g., size, shape, etc.), path shape, orientation, and/or the like that enables the mounting foot 108 to mount to one or more corresponding types of mounting rails and/or other mounting components of one or more types of mobile platforms. In some examples, one or more of the mounting feet 108 is configured to be received within a corresponding opening (e.g., a slot, a recess, a gap, etc.) of the mobile platform to facilitate mounting of the mounting foot 108 to a corresponding mounting rail and/or other mounting component of the mobile platform. Optionally, one or more of the mounting feet 108 is received within the corresponding opening with an interference, press, and/or clearance fit.

Another example of a configuration of a mounting foot 108 includes a mounting foot 108 that is configured to be mounted to a radial mounting rail of the corresponding mobile platform. For example, some examples of the mounting feet 108 extend radially outward from the ring clamp 112 along a radial axis of the ring clamp 112 (e.g., an axis that extends approximately perpendicular to the central axis 160, etc.).

Referring again to FIGS. 1 and 3, the mounting foot 110 of the clamshell 106 includes an elongated body 150 that extends outwardly from the ring clamp 114 of the clamshell 106. The body 150 of the mounting foot 110 is configured to mount to a specific corresponding mount type of one or more specific corresponding mobile platform types. As discussed above, FIGS. 6-8 illustrate examples of the mounting rails 142 and example respective mobile platform types 146 and 148 (the mounting feet 108 are not visible in FIG. 8). The example mounting feet 110 are configured to mount to each of the mounting rails 142 and are shown in FIGS. 6-8 as mounted thereto. Although two are shown, the clamshell 106 may include any number of the mounting feet 110.

Similar to the example mounting feet 108, the example of the mounting feet 110 shown herein are configured to mount to the corresponding mount type by being bolted to the corresponding mounting rail 142. However, the mounting feet 110 may additionally or alternatively be configured to mount to the corresponding mount type using any other fastener, fit, structure, means, geometry, mechanism, and/or the like. For example, the example mounting feet 110 generally have a rectangular cross-sectional shape and extend outward from the ring clamp 114 along an approximately straight path and with an orientation that extends approximately parallel to the central axis 162 of the ring clamp 114. In other words, each of the example mounting feet 110 extends longitudinally outward from the ring clamp 114 along the central axis 162 of the ring clamp 114. However, each mounting foot 110 may additionally or alternatively include any other geometry (e.g., size, shape, etc.), path shape, orientation, and/or the like that enables the mounting foot 110 to mount to one or more corresponding types of mounting rails and/or other mounting components of one or more types of mobile platforms.

In some examples, one or more of the mounting feet 110 is configured to be received within a corresponding opening (e.g., a slot, a recess, a gap, etc.) of the mobile platform to facilitate mounting of the mounting foot 110 to a corresponding mounting rail and/or other mounting component of the mobile platform. Optionally, one or more of the mounting feet 110 is received within the corresponding opening with an interference, press, and/or clearance fit. In another example, a mounting foot 110 is configured to be mounted to a radial mounting rail of the corresponding mobile platform (e.g., some examples of the mounting feet 110 extend radially outward from the ring clamp 114 along a radial axis of the ring clamp 114 (e.g., an axis that extends approximately perpendicular to the central axis 162, etc.).

The mounting feet 108 and 110 are configurable and standardized to fit (e.g., mount to, be complementary with, be received within, etc.) a specific corresponding mount type of one or more types of mobile platforms. A specific mount type may be dedicated to a single mobile platform type, or may be shared by two or more different types of mobile platforms. For example, the body 140 and 150 of each of the respective mounting feet 108 and 110 is configured to mount to the configuration of the mounting rails 142, which in an example implementation is shared by the mobile platform types 146 and 148. In some examples, the mounting feet 108 and 110 are configured to fit the same mount type (e.g., the example implementation shown herein, etc.), while in other examples the mounting feet 108 and 110 are configured to fit different mount types than each other.

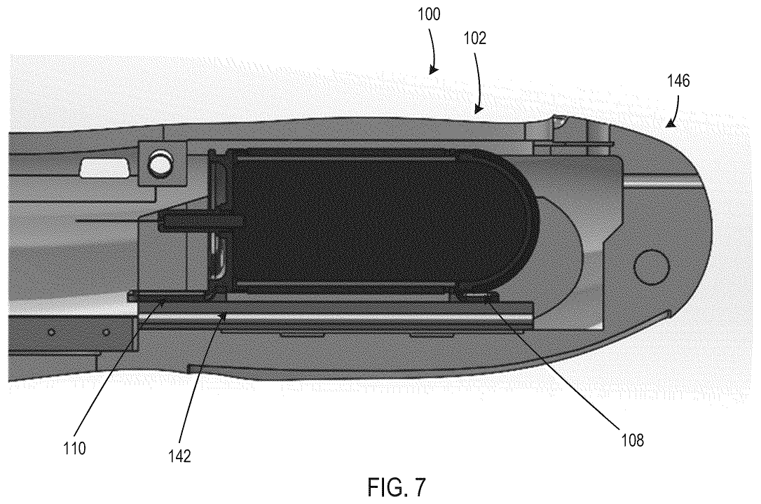

In some examples, the mounting feet 108 and/or 110 incorporate geometry-based verification features that employ geometries that enforce singular alignment orientations to secure the proper fit and orientation of the payload to the mobile platform. For example, the bodies 140 and 150 of the respective mounting feet 108 and 110 may include different geometries to prevent the payload 118 from being installed in all but one orientation. For example, in an example implementation, the different geometries of the mounting feet 108 and 110 prevent the bodies 140 and 150 from fitting within non-corresponding mounting openings when the orientation of the payload 118 is reversed (e.g., backwards, etc.) from the orientation shown in FIG. 1. For example, as can be seen from a comparison of FIGS. 2 and 3 and as shown in FIG. 7, the mounting feet 110 are longer than the mounting feet 108 in an example implementation shown herein. The longer body 150 of the mounting foot 110 does not fit in the mounting opening that corresponds to the mounting foot 108 when the orientation of the payload 118 is reversed (from FIG. 1), such that the payload 118 cannot be installed to the cradle 102 in the reversed (and incorrect) orientation. If both of the bodies 140 and 150 had the length of the mounting foot 108, the bodies 140 and 150 would fit within the non-corresponding mounting openings, thereby enabling the payload 118 to be held by the cradle 102 in the incorrect reverse orientation.

Although example implementations utilize different lengths of the bodies 140 and 150 to provide the geometry-based verification features, any other geometry-based verification feature may additionally or alternatively be used, such as, but not limited to, a shape, a height, a depth, a length, a diameter, an orientation, a path (e.g., of a length, etc.), a cross-sectional size, and/or the like. Examples of geometry-based verification features that include a difference in shape between the mounting feet 108 and 110 include, but are not limited to, a key, an irregular shape, a textured surface, a complex shape, a multi-sided shape, a barb, an extension, a finger, a stub, and/or the like.

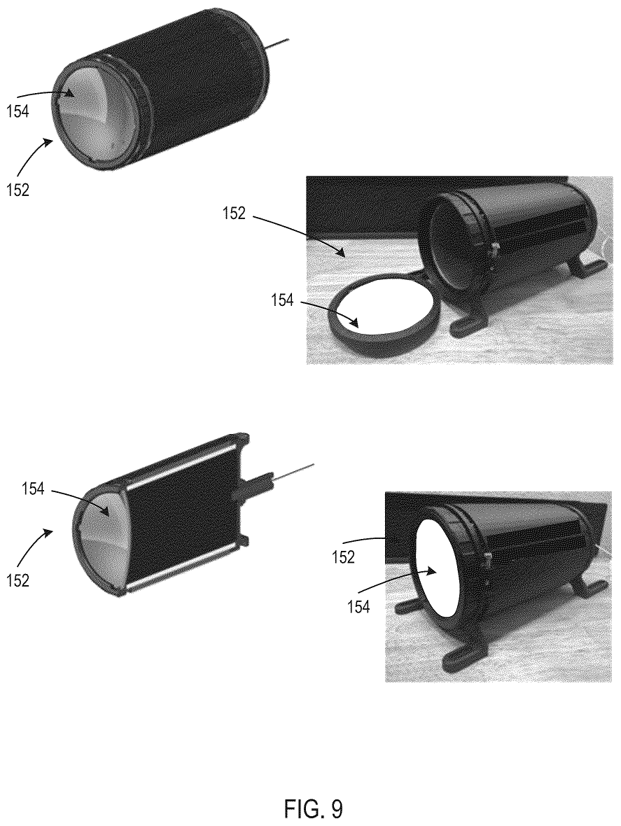

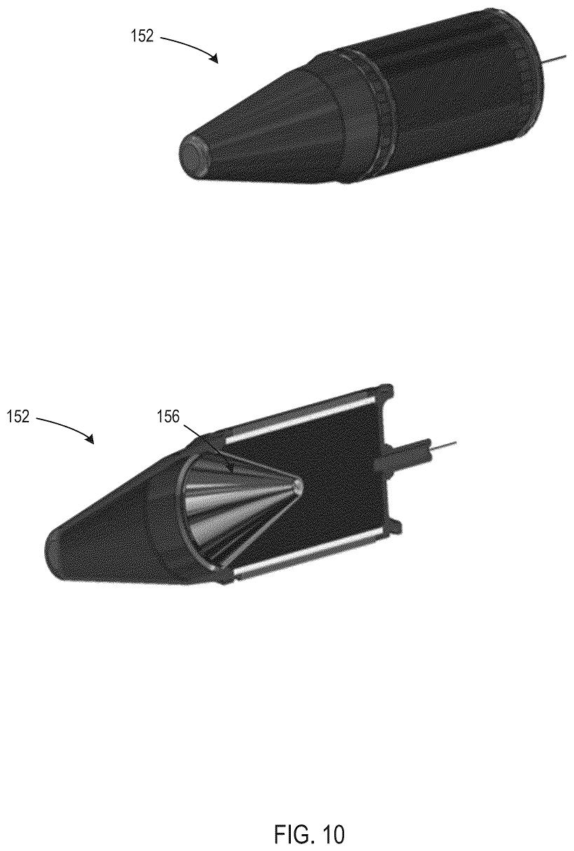

In some examples, the payload (e.g., the payload 118, the payload 518, etc.) is modular. For example, a front end portion 152 of the payload can be changed to implement a different of front end portion, such as a front end portion having a different shape (e.g., a cone, a half-dome, etc.), a front end portion of a different type, a front end portion having a different functionality, a front end portion including a shaped charge liner, and/or the like. FIGS. 9 and 10 illustrate various examples of the modularity of the front end portion 152 of the payload. For example, FIGS. 9 and 10 illustrate different example liners 154 and 156 (e.g., copper, tungsten, steel, etc.) and different example shapes of the front end portion 152.

Although shown as including a threaded connection to the casing (e.g., the casing 122, etc.) of the payload, the front end portion 152 may additionally or alternatively mount to the casing using any other fastener, fit, structure, means, geometry, mechanism, and/or the like. Examples of other fasteners include, but are not limited to, a clip, a latch, a clamp, a bayonet-type fastener, a quarter or half-turn fastener, a spring, a spring-loaded fastener, etc.

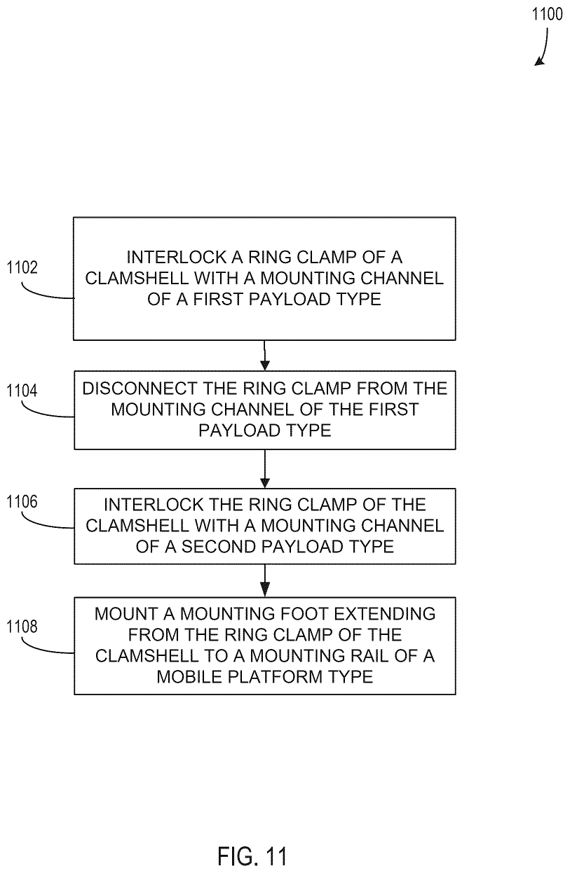

FIG. 11 is a flowchart illustrating an example of a method 1100 of operations, functions, and/or the like of the system 100 (FIG. 1). At 1102, the method 1100 includes interlocking a ring clamp of a clamshell with a mounting channel of a first payload type. At 1104, the method 1100 includes disconnecting the ring clamp from the mounting channel of the first payload type. The method 1100 includes interlocking, at 1106, the ring clamp of the clamshell with a mounting channel of a second payload type, wherein the second payload type is different from the first payload type.

Optionally, the method 1100 further includes mounting, at 1108, a mounting foot extending from the ring clamp of the clamshell to a mounting rail of a mobile platform type. In some examples, the ring clamp is a first ring clamp, the clamshell is a first clamshell, the mounting channel is a first mounting channel, and the method 1100 further includes:
interlocking a second ring clamp of a second clamshell with a second mounting channel of the first payload type; disconnecting the second ring clamp from the second mounting channel of the first payload type; and interlocking the second ring clamp of the second clamshell with a second mounting channel of the second payload type.

In some examples, the second payload type has a different size as compared to the first payload type.

Other Aspects, Examples, and/or Implementations

Aspects of the disclosure include a system that includes a cradle including first and second clamshells. The first clamshell includes a first ring clamp and a first mounting foot extending from the first ring clamp. The first mounting foot is configured to mount to a first mounting rail of a mobile platform type. The first ring clamp is configured to: interlock with a first mounting channel of a first payload type, and interlock with the first mounting channel of a second payload type that is different than the first payload type. The second clamshell includes a second ring clamp and a second mounting foot extending from the second ring clamp. The second mounting foot is configured to mount to a second mounting rail of the mobile platform type. The second ring clamp is configured to: interlock with a second mounting channel of the first payload type, and interlock with the second mounting channel of the second payload type.

In some examples, the first ring clamp includes a different geometry as compared to the second ring clamp.

In some examples, the first ring clamp includes at least one of a different shape or different size as compared to the second ring clamp.

In some examples, the second ring clamp includes a greater thickness along a central axis of the second ring clamp as compared to a thickness of the first ring clamp along a central axis of the first ring clamp.

In some examples, the second ring clamp includes a greater height along a radial axis of the second ring clamp as compared to a height of the first ring clamp along a radial axis of the first ring clamp.

In some examples, the second ring clamp includes a greater cross-sectional diameter as compared to a cross-sectional diameter of the first ring clamp.

In some examples, the first mounting foot includes at least one of a different geometry, shape, size, length, width, thickness, orientation, cross-sectional diameter, or mounting configuration as compared to the second mounting foot.

In some examples, at least one of the first ring clamp or the second ring clamp includes opposing free ends that are moved toward each other to secure the first ring clamp to the first mounting channel.

In some examples, the first ring clamp and the second ring clamp are configured to receive the first payload type therein, the first and second ring clamps being configured to receive the second payload type therein.

In some examples, the first ring clamp of the first clamshell is configured to receive a forward portion of the first and second payload types.

In some examples, the second ring clamp of the second clamshell is configured to receive a rearward portion of the first and second payload types.

In some examples, at least one of the first mounting foot or the second mounting foot extends longitudinally outward from the corresponding first or second ring clamp along a central axis of the corresponding first or second ring clamp.

In some examples, at least one of the first mounting foot or the second mounting foot extends radially outward from the corresponding first or second ring clamp along a radial axis of the corresponding first or second ring clamp.

In some examples, at least one of the first mounting foot or the second mounting foot is configured to be mounted to a radial rail.

In some examples, the mobile platform type includes at least one of an unmanned vehicle, an aircraft, a fixed wing aircraft, a rotor craft, a glider, a lighter-than-air craft, a balloon, a land vehicle, a marine vehicle, a surface vehicle, a submersible vehicle, a spade-based platform, or a platform carried by an individual.

Aspects of the disclosure include a system that includes a first mounting rail of a mobile platform type, a second mounting rail of a mobile platform type, and a cradle including first and second clamshells. The first clamshell includes a first ring clamp and a first mounting foot extending from the first ring clamp. The first mounting foot is configured to mount to the first mounting rail. The first ring clamp is configured to: interlock with a first mounting channel of a first payload type, and interlock with the first mounting channel of a second payload type that is different than the first payload type. The second clamshell includes a second ring clamp and a second mounting foot extending from the second ring clamp. the second mounting foot is configured to mount to the second mounting rail. The second ring clamp is configured to: interlock with a second mounting channel of the first payload type, and interlock with the second mounting channel of the second payload type.

Aspects of the disclosure include a method that includes interlocking a ring clamp of a clamshell with a mounting channel of a first payload type, disconnecting the ring clamp from the mounting channel of the first payload type, and interlocking the ring clamp of the clamshell with a mounting channel of a second payload type, wherein the second payload type is different from the first payload type.

In some examples, the method further includes mounting a mounting foot extending from the ring clamp of the clamshell to a mounting rail of a mobile platform type.

In some examples, the ring clamp is a first ring clamp, the clamshell is a first clamshell, the mounting channel is a first mounting channel, and the method further includes:
interlocking a second ring clamp of a second clamshell with a second mounting channel of the first payload type; disconnecting the second ring clamp from the second mounting channel of the first payload type; and interlocking the second ring clamp of the second clamshell with a second mounting channel of the second payload type.

In some examples, the second payload type has a different size as compared to the first payload type.

Aspects of the disclosure includes a method of mounting a payload using a cradle system. The method includes mounting a first mounting foot extending from a first ring clamp of a first clamshell to a first mounting rail of a mobile platform type; interlocking the first ring clamp with a first mounting channel of a first payload type; interlocking the first ring clamp with a first mounting channel of a second payload type, the second payload type being different from the first payload type; mounting a second mounting foot extending from a second ring clamp of a second clamshell to a second mounting rail of the mobile platform type; interlocking the second ring clamp with a second mounting channel of the first payload type; and interlocking the second ring clamp with a second mounting channel of the second payload type.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a cradle comprising first and second clamshells;
the first clamshell comprising a first ring clamp and a first mounting foot extending from the first ring clamp, the first mounting foot being configured to mount to a first mounting rail of a mobile platform type, wherein the first ring clamp is configured to:
interlock with a first mounting channel of a first payload type, and
interlock with the first mounting channel of a second payload type that is different than the first payload type; and
the second clamshell comprising a second ring clamp and a second mounting foot extending from the second ring clamp, the second mounting foot being configured to mount to a second mounting rail of the mobile platform type, wherein the second ring clamp is configured to:
interlock with a second mounting channel of the first payload type, and
interlock with the second mounting channel of the second payload type.

2. The system of claim 1, wherein the first ring clamp comprises a different geometry as compared to the second ring clamp.

3. The system of claim 1, wherein the first ring clamp comprises at least one of a different shape or different size as compared to the second ring clamp.

4. The system of claim 1, wherein the second ring clamp comprises a greater thickness along a central axis of the second ring clamp as compared to a thickness of the first ring clamp along a central axis of the first ring clamp.

5. The system of claim 1, wherein the second ring clamp comprises a greater height along a radial axis of the second ring clamp as compared to a height of the first ring clamp along a radial axis of the first ring clamp.

6. The system of claim 1, wherein the second ring clamp comprises a greater cross-sectional diameter as compared to a cross-sectional diameter of the first ring clamp.

7. The system of claim 1, wherein the first mounting foot comprises at least one of a different geometry, shape, size, length, width, thickness, orientation, cross-sectional diameter, or mounting configuration as compared to the second mounting foot.

8. The system of claim 1, wherein at least one of the first ring clamp or the second ring clamp comprises opposing free ends that are moved toward each other to secure the first ring clamp to the first mounting channel.

9. The system of claim 1, wherein the first ring clamp and the second ring clamp are configured to receive the first payload type therein, the first and second ring clamps being configured to receive the second payload type therein.

10. The system of claim 1, wherein the first ring clamp of the first clamshell is configured to receive a forward portion of the first and second payload types.

11. The system of claim 1, wherein the second ring clamp of the second clamshell is configured to receive a rearward portion of the first and second payload types.

12. The system of claim 1, wherein at least one of the first mounting foot or the second mounting foot extends longitudinally outward from the corresponding first or second ring clamp along a central axis of the corresponding first or second ring clamp.

13. The system of claim 1, wherein at least one of the first mounting foot or the second mounting foot extends radially outward from the corresponding first or second ring clamp along a radial axis of the corresponding first or second ring clamp.

14. The system of claim 1, wherein at least one of the first mounting foot or the second mounting foot is configured to be mounted to a radial rail.

15. The system of claim 1, wherein the mobile platform type comprises at least one of an unmanned vehicle, an aircraft, a fixed wing aircraft, a rotor craft, a glider, a lighter-than-air craft, a balloon, a land vehicle, a marine vehicle, a surface vehicle, a submersible vehicle, a spade-based platform, or a platform carried by an individual.

16. A system comprising:
a first mounting rail of a mobile platform type;
a second mounting rail of a mobile platform type; and
a cradle comprising first and second clamshells;
the first clamshell comprising a first ring clamp and a first mounting foot extending from the first ring clamp, the first mounting foot being configured to mount to the first mounting rail, wherein the first ring clamp is configured to:
interlock with a first mounting channel of a first payload type, and
interlock with the first mounting channel of a second payload type that is different than the first payload type; and
the second clamshell comprising a second ring clamp and a second mounting foot extending from the second ring clamp, the second mounting foot being configured to mount to the second mounting rail, wherein the second ring clamp is configured to:
interlock with a second mounting channel of the first payload type, and
interlock with the second mounting channel of the second payload type.

17. A method comprising:
interlocking a ring clamp of a clamshell with a mounting channel of a first payload type;
disconnecting the ring clamp from the mounting channel of the first payload type; and
interlocking the ring clamp of the clamshell with a mounting channel of a second payload type, wherein the second payload type is different from the first payload type.

18. The method of claim 17, further comprising mounting a mounting foot extending from the ring clamp of the clamshell to a mounting rail of a mobile platform type.

19. The method of claim 17, wherein the ring clamp is a first ring clamp, the clamshell is a first clamshell, and the mounting channel is a first mounting channel, the method further comprising:
interlocking a second ring clamp of a second clamshell with a second mounting channel of the first payload type;
disconnecting the second ring clamp from the second mounting channel of the first payload type; and
interlocking the second ring clamp of the second clamshell with a second mounting channel of the second payload type.

20. The method of claim 17, wherein the second payload type has a different size as compared to the first payload type.
